(19) United States
(12) Patent Application Publication
(10) Pub. No.: US 2018/0268435 A1
(43) Pub. Date: Sep. 20, 2018

(54) Presenting a Content Item Based on User Interaction Data

(71) Applicant: Google Inc., Mountain View, CA (US)

(72) Inventor: Juhyun Lee, San Jose, CA (US)

(73) Assignee: Google Inc., Mountain View, CA (US)

(21) Appl. No.: 14/019,368

(22) Filed: Sep. 5, 2013

(51) Int. Cl. G06Q 30/02

(52) U.S. Cl. CPC G06Q 30/0241

(57) ABSTRACT

In one aspect, a method includes receiving user interaction data corresponding to a plurality of user interactions expressing interest in a content item, identifying a non-skippable portion of the content item based on the received user interaction data, and presenting the identified non-skippable portion of the content item to a user before allowing the user to skip any remaining portion following the non-skippable portion of the content item.

### BACKGROUND

This specification relates to the presentation of content items.

Media content, sometimes called “in-stream” content, may be presented in a video or audio stream. For example, an in-stream video advertisement may be presented before, during, or after the delivery of free online video content. An in-stream video advertisement may delay or interrupt video content, and may typically last 15 to 30 seconds.

### SUMMARY

This specification describes technologies relating to presenting a content item based on user interaction data. When a content item is presented to users, the users may interact with the content item differently. Some users may skip the content item before or during playback of the content item. Some users may allow the content item to play back in its entirety. Other users may select a link associated with the content item that directs them to a website of a provider of the content item (e.g., an advertiser). Data regarding such past interactions with the content item may be used to affect future presentations of the content item. For example, data regarding such interactions may be used to classify a content item as a non-skippable content item or a skippable content item. If the content item is classified as a skippable content item, the data may be used to identify a non-skippable portion of the content item.

In general, one innovative aspect of the subject matter described in this specification can be implemented in methods that may include receiving user interaction data corresponding to a plurality of user interactions expressing interest in a content item, identifying a non-skippable portion of the content item based on the received user interaction data, and presenting the identified non-skippable portion of the content item to a user before allowing the user to skip any remaining portion following the non-skippable portion of the content item.

These and other implementations can optionally include one or more of the following features. The content item may include one of an audio advertisement or a video advertisement. The received user interaction data may include one or more of click-through data, conversion data, play-through data, or playback duration data associated with the content item. Identifying the non-skippable portion of the content item may include determining a position in the content item based on the received user interaction data, the position associated with optimal interaction statistics for the content item, and identifying, as the non-skippable portion of the content item, a portion of the content item that includes the determined position. The optimal interaction statistics may include a highest click-through rate of a plurality of click-through rates associated with the content item, each click-through rate of the plurality of click-through rates associated with a different position in the content item. Identifying the non-skippable portion of the content item may include determining that the content item has undesirable interaction statistics based on the received user interaction data, and identifying, as the non-skippable portion of the content item, a beginning of the content item to an end of the content item. The undesirable interaction statistics may include one or more of a low overall click-through rate, a low overall conversion rate, a low play-through rate, or a low average playback duration associated with the content item. The identified non-skippable portion of the content item may include an entirety of the content item, and the method may include converting the content item from a skippable content item to a non-skippable content item. The identified non-skippable portion of the content item may include less than an entirety of the content item, and the method may include converting the content item from a non-skippable content item to a skippable content item. The method may include, after presenting the identified non-skippable portion of the content item to the user, presenting an option to the user to skip the any remaining portion following the non-skippable portion of the content item. Presenting the option to the user to skip the any remaining portion following the identified non-skippable portion of the content item may include adjusting a skip enablement threshold associated with the content item and presenting the option to the user based on the skip enablement threshold.

Particular implementations of the subject matter described in this specification may be implemented to realize one or more of the following potential advantages. Data regarding user interactions expressing interest in a content item can be used to determine where content that is likely of interest to users occurs in the content item, and to determine how much of the content item to play back to users before allowing users to skip the content item. Determining where in content items the likely interesting content occurs for individual content items may provide content item providers with the freedom to choose how to present their content items. If the content item includes content that is likely of interest to users, presenting such content to the users before allowing the users to skip the content item may increase the likelihood that the users will view or hear the likely interesting content, and thereby increase the likelihood of conversions. If the content item is determined likely not to include content that is interesting to users, allowing users to skip the content item before or shortly after starting playback may preserve a user friendly experience, and thereby foster goodwill with a provider of the content item and a publisher of a publication in which the content item is presented to the users.

Details of one or more implementations of the subject matter described in this specification are set forth in the accompanying drawings and description below. Other features, aspects, and potential advantages of the subject matter will become apparent from the description, the drawings, and the claims.

### BRIEF DESCRIPTION OF THE DRAWINGS

FIG. 1 is a block diagram of an example of an environment for presenting content items.

FIG. 2 is a diagram of a web browser user interface with a video player region.

FIGS. 3A and 3B show a diagram of a video player region during playback of video content.

FIG. 4 is a flowchart of an example of a process for presenting a content item based on user interaction data.

FIG. 5 shows a block diagram of a programmable processing system.

### DETAILED DESCRIPTION

Various implementations described in this specification are discussed below in the context of in-stream video advertisements. The technologies described in this specification may be used for the presentation of other content. The term “content” refers to various types of presented information, such as articles, discussion threads, reports, analyses, financial statements, music, video, graphics, search results, web page listings, information feeds (e.g., RSS feeds), advertisements, and other web-based information. For example, the techniques may be used for presenting in-stream audio advertisements. As another example, the techniques may be used for presenting audio or video clips to a user who may be interested in purchasing the respective audio or video file. Other implementations may include components different from those described herein.

A content item may be classified as a skippable content item or a non-skippable content item. A skippable content item is a content item that may be skipped by a user before or during playback of the content item. A non-skippable content item is a content item that is played back in its entirety before, for example, starting or resuming playback of feature content that was delayed or interrupted by the presentation of the content item, or starting playback of other unrelated content in the same audio or video player user interface used to present the non-skippable content item. When a content item is presented to users, the users may interact with the content item differently. If the content item is a skippable content item, some users may skip the content item before or during playback of the content item, and some users may allow the content item to play back in its entirety. Other users may select a link associated with the content item that directs them to a website of a provider of the content item (e.g., an advertiser). Data regarding such past interactions with the content item may be used to affect future presentations of the content item.

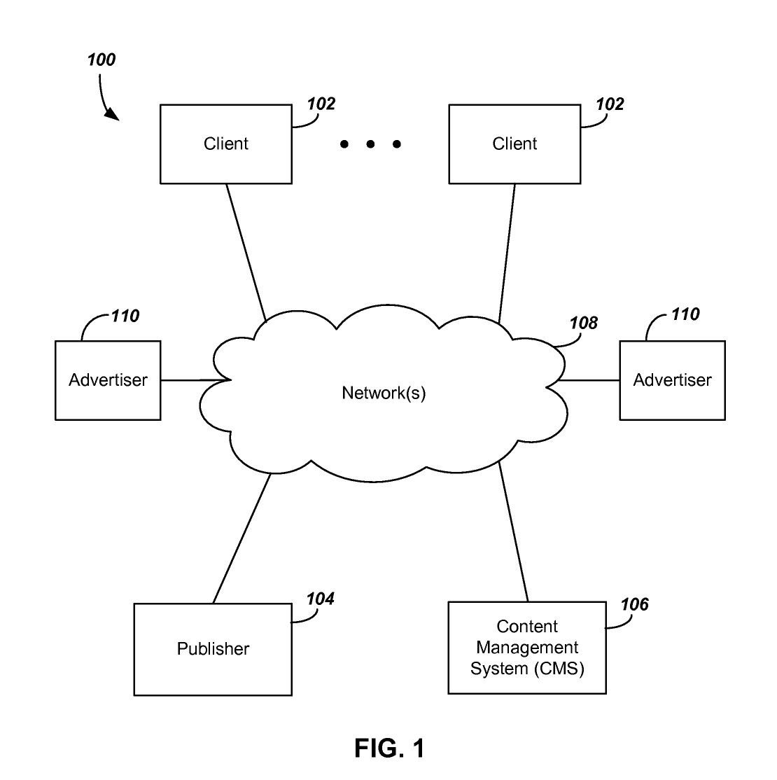

FIG. 1 is a block diagram of an example of an environment 100 for presenting content items, such as publication content and advertisements. The environment 100 includes one or more clients 102, a publisher 104, one or more advertisers 110, a content management system (CMS) 106, and one or more networks 108 for interconnecting these components. The one or more networks may include a local area network (LAN), a wide-area network (WAN), the Internet, a wired network, a wireless network, or a combination thereof. The environment 100 may connect many thousands of clients 102, publishers 104, and advertisers 110.

The publisher 104 may include a content provider with an Internet presence, such as online publication and news providers (e.g., online newspapers, online magazines, or television websites), online service providers (e.g., financial service providers or health service providers), and other content providers. The publishers 104 may include entities that generate, maintain, provide, present, or process online content and online publications in the environment 100. The term “publication” refers to any data that can be provided by the publisher 104 over the network 108. Publications can include, for example, HTML pages (e.g., web pages), word processing documents, portable document format documents, or RSS feeds. A publication can include content, such as text, images, audio, or video, and may include embedded information, such as meta-information or hyperlinks, and/or embedded instructions, such as markup language (e.g., XML, HTML, etc.), scripts (e.g., JavaScript scripts), or applets. The publisher 104 stores content and provides content to clients 102. The content provided by the publisher 104 may include video content. Video content includes any content that can be visually perceived when played, decoded, or rendered. Video content may be stored or streamed. Examples of video content may include a television program, a dramatic work, a music video, or a video voice message.

The CMS 106 stores information associated with advertisements and provides tools to advertisers or sponsors for creating and managing advertising campaigns. For example, the CMS 106 may store interaction data collected from users. In some implementations, the CMS 106 may store advertisements provided by the advertisers 110. The advertisers 110 may access the CMS 106 through network 108 to create an advertising campaign, provide advertisements, control the placement of the advertisements (e.g., to particular content or categories), bid for advertisement placements, monitor statistics associated with the advertising campaign, specify criteria for the presentation of the advertisements (e.g., a skip enablement threshold, a classification of the advertisement as skippable or non-skippable), and make payments associated with the advertising campaign. An advertisement may be any content designed to promote a product or a service, or to give the public a notice of some subject matter. An advertisement may include any combination of text, still graphics or images, moving graphics or images (e.g., video or animation), and audio.

In some implementations, video advertisements provided by the advertisers 110 are stored at the publisher 104. When an advertisement is requested by a client 102, the request may be sent to the CMS 106. The CMS 106 determines the advertisement to be placed for the request. The CMS 106 forwards instructions to the publisher 104 to deliver the advertisement, and the publisher 104 transmits the advertisement to the client 102 through the network 108.

The clients 102 may be any devices capable of receiving content. Examples of clients 102 may include personal computers, mobile phones, wireless devices, game consoles, tablets, media centers, consumer electronics, personal digital assistants, television systems, and media players. The content that can be received by the clients 102 may include documents, such as web pages, audio content, and video content. The audio content or video content may be played in an audio player or a video player module or application. The audio player module or video player module may be a standalone application, a plug-in to another application, or instructions downloaded from another computer or device.

In some implementations, the audio or video content may be displayed within a web browser. For example, a web page may include embedded audio or an embedded video. The embedded audio or video is referenced within the web page by a universal resource locator (URL) of the audio or video. When the web browser renders and displays the web page, an audio or video player module is activated, audio or video is retrieved from the URL, and the audio or video is played within the displayed web page.

Advertisements may be selected based on audio or video content and displayed with audio or video content. In some implementations, ads may be displayed alongside of, on top of, or otherwise in proximity to the audio or video content. For example, a video may be displayed in one region of a user interface, and advertisements may be displayed in an adjacent region.

In some implementations, audio or video advertisements may be added to audio or video content. When the audio or video content is displayed at a client 102, the added audio or video advertisements may be displayed in-stream with the audio or video content. For example, one or more video advertisements may be shown in advertisement breaks or slots within a video. An advertisement slot is a span of time in a video that is reserved for presenting video advertisements. An advertisement slot may be located anywhere in the video, including at the beginning (before the feature content of the video), in between portions of the video, or at the end (after the feature content of the video). A video may have one or more advertisement slots. An advertisement slot may be of any non-zero length, e.g., 30 seconds or 60 seconds. In some implementations, the advertisement slot may have a maximum length, and the total running time of one or more video advertisements placed in the advertisement slot may be less than or equal to the maximum length of the slot.

For purposes of explanation only, certain aspects of this disclosure are described with reference to the discrete elements illustrated in FIG. 1. The number, identity, and arrangement of elements in the environment 100 are not limited to what is shown. For example, the environment 100 can include any number of geographically-dispersed publishers 104, advertisers 110, and clients 102, which may be discrete, integrated modules or distributed systems. Similarly, the environment 100 is not limited to a single CMS 106 and may include any number of integrated or distributed CMS systems or elements.

Furthermore, additional or different elements not shown may be contained in or coupled to the elements shown in FIG. 1, or certain illustrated elements may be absent. In some examples, the functions provided by the illustrated elements can be performed by less than the illustrated number of components or even by a single element. The illustrated elements can be implemented as individual processes run on separate machines or a single process running on a single machine.

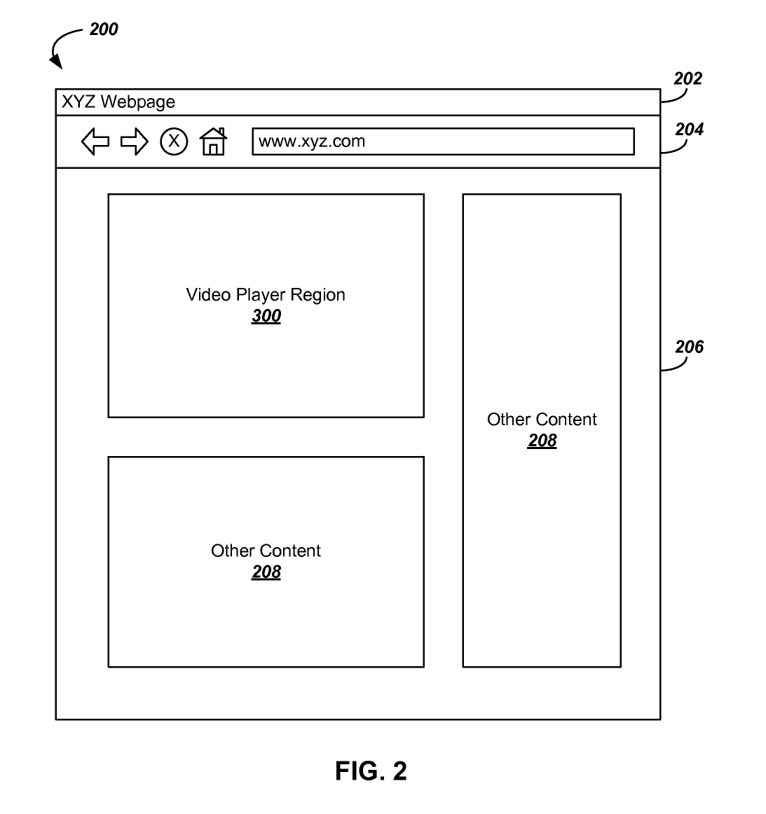

FIG. 2 is a diagram of a web browser user interface 200 with a video player region 300. The video player region 300 may display a user interface for viewing a video and controlling the viewing of the video. While FIG. 2 shows a web browser user interface 200 for viewing videos, a video player user interface may be displayed without a web browser interface. For example, a standalone video player application may include a video player user interface.

The web browser user interface 200, which may be displayed at a client 102, includes a title bar 202, a navigation bar 204, and a content area 206. The title bar 202 displays information regarding the content displayed in the content area 206. In some implementations, the title bar 202 displays a title of the content displayed in the content area 206. The navigation bar 204 includes navigational controls for navigating between documents such as web pages. Examples of navigational controls include back, forward, stop, and home controls. The navigation bar 204 may include an address bar showing the URL of the content (e.g., a web page) displayed in the content area 206.

Content may be displayed in the content area 206. In some implementations, the content is a web page. In some implementations, a video player region 300 may be displayed in the content area 206. In some implementations, other content 208 may be displayed along with the video player region 300. In some implementations, the other content 208 may include text, graphics, advertisements (e.g., text ads, graphics, links, banners), previews of videos (e.g., thumbnails of video frames), information about the displayed video or advertisements, links, or user-selectable controls.

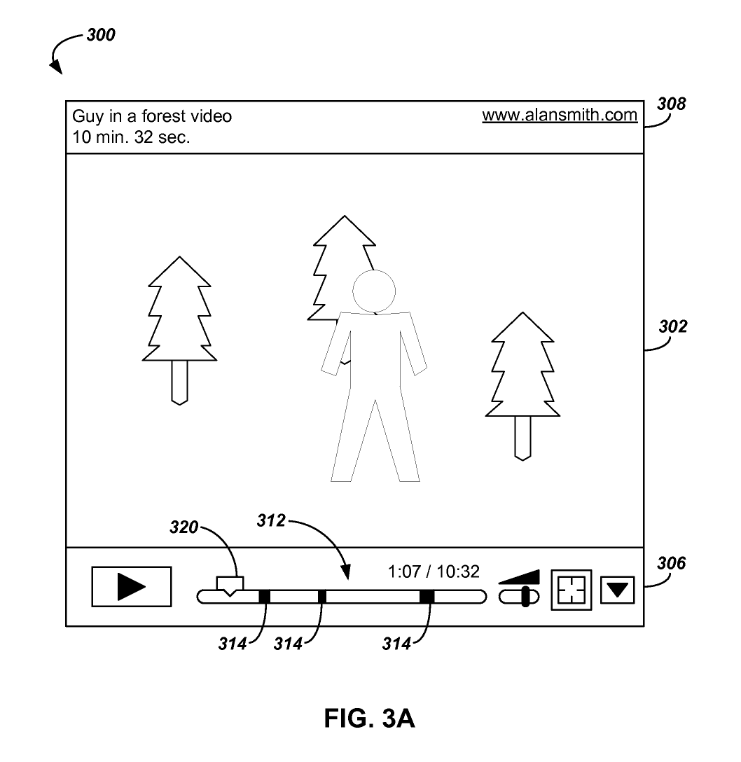

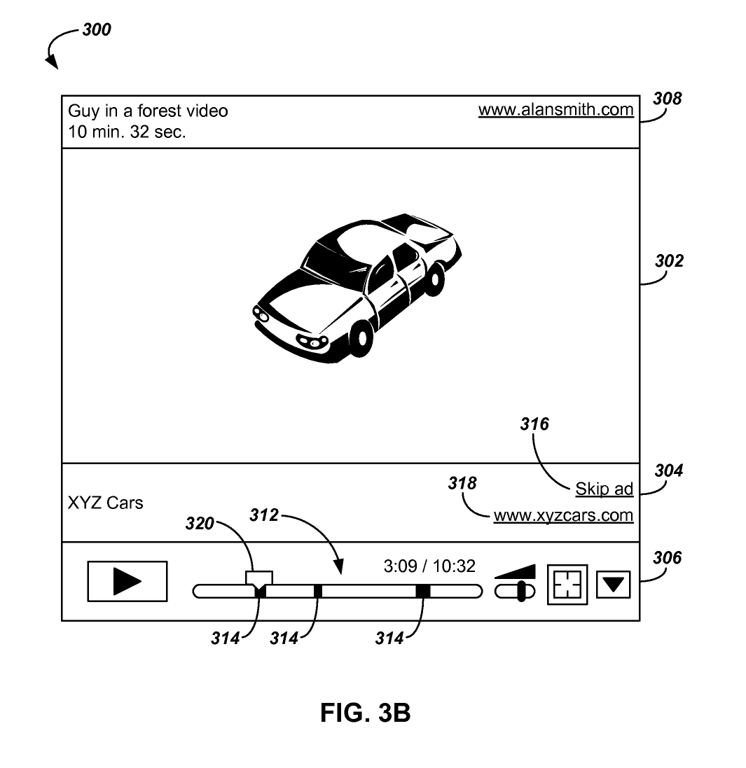

FIGS. 3A and 3B show a diagram of a video player region 300 during playback of video content. The user interface of the video player region 300 includes an area 302 for displaying a video. The user interface of the video player region 300 may include a video information area 308 and a control area 306. The information area 308 provides information regarding the video being displayed. The control portion 306 includes controls for controlling playback of the video (e.g., play, pause, reverse, fast forward, volume, full screen, or skip). The control portion 306 may include a scrubber or progress bar 312 and a playhead 320. The progress bar 312 represents the total length of the video. The playhead 320 indicates, by its position relative to the length of the progress bar 320, which frame of the video is being displayed.

The progress bar 312 may display one or more advertisement slots 314. In some implementations, the advertisement slots 314 are indicated as vertical bars in the progress bar 312. The advertisement slots 314 indicate positions in the video stream where video advertisements may be placed for display to a user.

In FIG. 3A, the playhead 320 indicates a position on the progress bar 312 corresponding to a video provided by a publisher. The frame displayed in the video content display area 302 is a frame from the video.

In FIG. 3B, the playhead indicates a position on the progress bar 312 corresponding to an advertisement slot 314. The frame displayed in the video content display area 302 is a frame from a placed video advertisement. While a video advertisement is being displayed, an advertisement information area 304 may be displayed. The advertisement information area 304 may display the name of the advertiser or sponsor associated with the video advertisement being displayed. The advertisement information area 304 may display a resource link 318. When the resource link 318 is selected by a user, the resource link 318 may direct the user to a resource associated with the advertisement (e.g., a website of the advertiser or sponsor). The advertisement information area 304 may also include a skip advertisement link or control 316. When the skip advertisement link or control 316 is selected by the user, the currently displayed video advertisement is skipped and playback of the feature video resumes (or stops if the skipped video advertisement is located after the end of the feature video). The skip advertisement link or control 316 may be a link, a button, a selectable icon, or some other user-selectable user interface object.

When a video advertisement is displayed to users, the users may interact with the video advertisement differently. Some users may skip the video advertisement before or shortly after it begins playing. Some users may skip the video advertisement after it plays for a number of seconds. Some users may allow the video advertisement to play back in its entirety. Some users may select a link associated with the video advertisement that directs the users to a website of the advertiser. Data regarding such interactions may be used to affect the presentation of the video advertisement.

For example, data regarding user interactions expressing interest in a content item can be used to determine where content that is likely of interest to users occurs in the content item, and to determine what portion or how much of the content item to play back to users. The determined portion or amount of the content item can be played back to users before allowing users to skip the content item. Data regarding such interactions may be used to classify a content item as a non-skippable content item or a skippable content item. A skippable content item is a content item that may be skipped by a user before or during playback of the content item. A non-skippable content item is a content item that is played back in its entirety before, for example, starting or resuming playback of feature content that was delayed or interrupted by the presentation of the content item, or starting playback of other unrelated content in the same audio or video player user interface used to present the non-skippable content item. If the content item is classified as a skippable content item, the interaction data may be used to identify a non-skippable portion of the content item. The non-skippable portion of the content item includes a portion of the content item that is played back in its entirety before, for example, starting or resuming playback of feature content that was delayed or interrupted by the presentation of the content item, or starting playback of other unrelated content in the same audio or video player user interface used to present the content item.

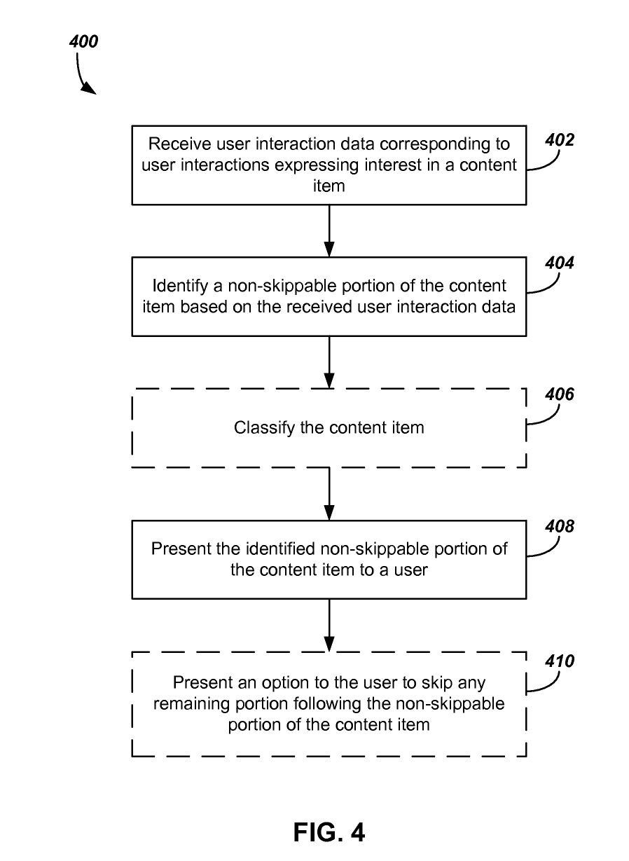

FIG. 4 is a flowchart of an example of a process 400 for presenting a content item, such as an audio advertisement or video advertisement, based on user interaction data. The process 400 may be performed by a content management system (CMS) that includes one or more computers, such as CMS 106 of FIG. 1.

At 402, the CMS receives user interaction data corresponding to user interactions associated with a content item. The user interaction data may include interaction data associated with multiple users to whom the content item was presented. In some implementations, the interaction data may be collected for a content item, but not associated with any particular user. In some implementations, the interaction data may be collected for and associated with particular users.

The user interaction data may include user interactions expressing interest in the content item. The user interaction data may include, for example, a number of times the content item was presented to users, click-through data for a resource link that directs users to a resource associated with the content item (e.g., click-through rate), conversion data, play-through data (e.g., a play-through rate defined as the ratio of the number of times the content item was played all the way through to the number of times playback of the content item was started), or playback duration data (e.g., average playback duration before the content item was skipped by a user).

A conversion may occur when a user performs a particular action desired by the provider of the content item. For example, a conversion may occur when a user consummates a transaction rated to the content item. A conversion can be defined to occur when a user clicks on a resource link associated with the content item, is referred to the content item provider's web page, and consummates a purchase before leaving that web page. A conversion may occur when the content item is presented to a user and the user makes a corresponding purchase on the content item provider's web page within a predetermined time (e.g., seven days). A conversion may also be defined by the content item provider to be any measurable or observable user action, such as downloading a white paper, navigating to at least a given depth of a website, viewing at least a certain number of web pages, spending at least a predetermined amount of time on a website or a web page, or registering on a website. Other forms of conversion are possible.

At 404, the CMS identifies a non-skippable portion of the content item based on the received user interaction data. The non-skippable portion of the content item may include content that is likely of interest to users. The CMS determines what content of the content item is likely of interest to users based on user interactions expressing interest in the content item. The non-skippable portion of the content item may be a portion less than the entire content item, or it may be the entire content item.

In some implementations, the CMS may identify the non-skippable portion of the content item by determining a position in the content item that is associated with optimal interaction statistics for the content item. For example, the user interaction data may indicate click-through rates for different positions in the content item or for different playback durations of the content item. Based on the optimal interaction statistics, the CMS may determine that the highest click-through rate associated with the content item occurs at a particular position or after a particular playback duration. The CMS may identify, as the non-skippable portion of the content item, a portion that includes the particular position or a portion having the particular playback duration. As another example, the user interaction data may indicate conversion rates for different playback durations of the content item. Based on the optimal interaction statistics, the CMS may determine that the highest conversion rate associated with the content item occurs after a particular playback duration. The CMS may identify, as the non-skippable portion of the content item, a portion having the particular playback duration.

In some implementations, the CMS may identify the non-skippable portion of the content item by determining that the content item has undesirable interaction statistics based on the received user interaction data. Undesirable interaction statistics associated with the content item may include, for example, a low overall click-through rate, a low overall conversion rate, a low play-through rate, or a low average playback duration.

In some implementations, the CMS may identify, as the non-skippable portion of the content item, an entirety of the content item including the beginning of the content item to the end of the content item based on the undesirable interaction statistics. For example, the CMS may determine that the content item has a low overall click-through rate and a low average playback duration. The low overall click-through rate and the low average playback duration may be a result of users selecting an option to skip the content item within the first five seconds after starting playback of the content item. The CMS may identify the entirety of the content item as the non-skippable portion in order to collect user interaction data for portions of the content item that are presented to users after the first five seconds of playback.

In some implementations, the CMS may identify, as the non-skippable portion of the content item, a predetermined amount or playback duration, e.g., 5 seconds, of the content item. For example, the CMS may determine that the content item has a low overall click-through rate but a high average playback duration. The low overall click-through rate and the high average playback duration may be a result of users viewing or listening to a majority of the content item without clicking on a resource link associated with the provider of the content item. The CMS may determine that users are likely not interested in the content item or that the content item is likely not interesting to users, and identify a predetermined amount of the content item as the non-skippable portion. Allowing users to skip content items that are determined to be likely not to include content that is interesting before or shortly after starting playback may preserve a user friendly experience, and thereby foster goodwill with the provider of the content item and a publisher of a publication in which the content item is presented to the user.

At 406, the CMS may classify the content item as a skippable content item or a non-skippable content item. The CMS may classify the content item based on, for example, the received user interaction data, input from a provider of the content item, or both. The CMS may convert the content item from a skippable content item to a non-skippable content item, or from a non-skippable content item to a skippable content item. If the content item was previously classified as a skippable content item and the CMS identifies the entirety of the content item as the non-skippable portion, the CMS may convert the skippable content item to a non-skippable content item. If the content item was previously classified as a non-skippable content item and the CMS identifies less than the entirety of the content item as the non-skippable portion, the CMS may convert the non-skippable content item to a skippable content item. To classify or convert the content item, the CMS may associate data with the content item to indicate whether the content item is a non-skippable content item or a skippable content item.

At 408, the CMS presents the identified non-skippable portion of the content item to a user. The CMS may present the identified non-skippable portion before starting or resuming playback of feature content that was delayed or interrupted by the presentation of the content item. The CMS may present the identified non-skippable portion before starting playback of other unrelated content in the same audio or video player user interface used to present the non-skippable content item. The CMS may present the identified non-skippable portion of the content item before allowing the user to skip any remaining portion following the non-skippable portion of the content item. Presenting the identified non-skippable portion of the content item before allowing the user to skip any remaining portion or before playing back other content may, for example, increase the likelihood that the user will view or hear content of the content item that is determined to be likely of interest to the user, and thereby increase the likelihood of a conversion.

If the content item is a skippable content item, the CMS may present an option to the user to skip any remaining portion following the identified non-skippable portion of the content item at 410. For example, the CMS may present a control such as the skip advertisement control 316 of FIG. 3. The CMS may present the option to the user after presenting the identified non-skippable portion of the content item to the user. To present the option to the user, the CMS may determine or adjust a skip enablement threshold associated with the content item. The skip enablement threshold may indicate an amount or duration of the content item that must be played back to the user before the option is presented to the user. The CMS may determine or adjust the skip enablement threshold based on, for example, the received user interaction data, a minimum threshold specified by a provider of the content item, an amount of the content item that is non-skippable, or a duration of the identified non-skippable portion. The CMS may present the option to the user based on the skip enablement threshold, for example, after the amount of the content item indicated by the skip enablement threshold has been presented to the user or the duration of the identified non-skippable portion indicated by the skip enablement threshold has elapsed.

While the above systems and techniques are described in the context of audio and video advertisements, the systems and techniques may be used for presentation of other types of content items, such as audio samples and video samples. For example, users may be provided with a sample of an audio file or a video file that can be purchased. The sample or portion of the audio file or video file provided to the users may be identified based on user interaction data associated with the audio file or video file. The sample may be skippable by users at any time before or during playback of the sample. Presenting the identified portion of the audio file or video file may increase the likelihood of a purchase.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

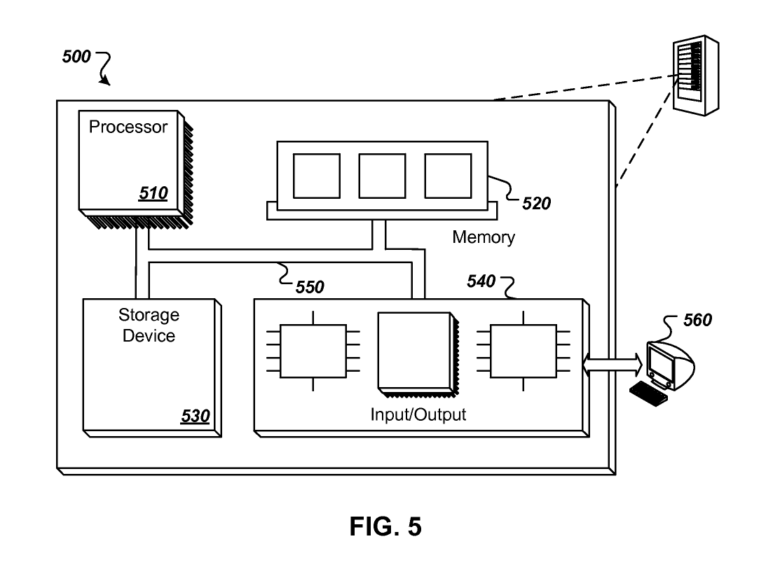

An example of one such type of computer is shown in FIG. 5, which shows a block diagram of a programmable processing system (system). The system 500 that can be utilized to implement the systems and methods described herein. The architecture of the system 500 can, for example, be used to implement a computer client, a computer server, or some other computer device.

The system 500 includes a processor 510, a memory 520, a storage device 530, and an input/output device 540. Each of the components 510, 520, 530, and 540 can, for example, be interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 560.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can be implemented in combination in a single implementation. Conversely, various features that are described in the context of a single implementation can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
adding, by a processor of a content management system (CMS), an in-stream segment to a content item;
receiving, by the processor, user interaction data corresponding to a plurality of previous user interactions expressing interest in the in-stream segment of the content item, the in-stream segment being defined by at least one point of time during playback of the content item;
for each of the at least one point of time during playback of the in-stream segment, determining, by the processor, from the received user interaction data, a click-though rate for said point of time during playback of the in-stream segment;
determining, by the processor, a first point of time during playback of the in-stream segment having a highest click-through rate, wherein the first point in time is the time elapsed from initiating playback of the in-stream segment;
classifying, by the processor, a portion of the in-stream segment defined by a time of initiating playback of the segment and the first point in time as the non-skippable portion followed by a subsequent skippable portion;
while presenting the in-stream segment of the content item to a user of a client device, detecting, by the processor, that an elapsed time of the presentation of the in-stream segment to the user matches the duration of the non-skippable portion; and
in response to detecting that the elapsed time of the presentation of the content item to the user matches the duration of the non-skippable portion, initiating, by the processor, display of a user interface element, detection of an interaction with the user interface element causing the CMS to skip the subsequent skippable portion following the non-skippable portion of the in-stream segment.

2. The method of claim 1, wherein the in-stream segment comprises one of an audio advertisement or a video advertisement.

3. The method of claim 1, wherein the received user interaction data comprises one or more of click-through data, conversion data, play-through data, or playback duration data associated with the in-stream segment.

4. The method of claim 1, further comprising:
identifying, as the non-skippable portion of the in-stream segment, a portion of the in-stream segment that includes the point of time during playback of the content item.

5. The method of claim 1, wherein the interaction data comprises a highest click-through rate of a plurality of click-through rates associated with the in-stream segment, each click-through rate of the plurality of click-through rates associated with a different playback time in the in-stream segment.

6. The method of claim 1, further comprising:
identifying, as the non-skippable portion of the in-stream segment, a beginning of the in-stream segment to an end of the in-stream segment.

7. The method of claim 6, wherein the the non-skippable portion is identified based on overall click-through rate, an overall conversion rate, an play-through rate, or an average playback duration associated with the content item.

8. (canceled)

9. The method of claim 1, further comprising:
converting the in-stream segment from a non-skippable content item to a skippable content item.

10. (canceled)

11. (canceled)

12. A non-transitory computer storage medium encoded with instructions that when executed by a data processing device cause the data processing device to perform operations comprising:
adding, by a processor of a content management system (CMS), an in-stream segment to a content item;
receiving, by the processor, user interaction data corresponding to a plurality of previous user interactions expressing interest in the in-stream segment of the content item, the in-stream segment being defined by at least one point of time during playback of the content item;
for each of the at least one point of time during playback of the in-stream segment, determining, by the processor, from the received user interaction data, a click-though rate for said point of time during playback of the in-stream segment;
determining, by the processor, a first point of time during playback of the in-stream segment having a highest click-through rate, wherein the first point in time is the time elapsed from initiating playback of the in-stream segment;
classifying, by the processor, a portion of the in-stream segment defined by a time of initiating playback of the segment and the first point in time as the non-skippable portion followed by a subsequent skippable portion;
while presenting the in-stream segment of the content item to a user of a client device, detecting, by the processor, that an elapsed time of the presentation of the in-stream segment to the user matches the duration of the non-skippable portion; and
in response to detecting that the elapsed time of the presentation of the content item to the user matches the duration of the non-skippable portion, initiating, by the processor, display of a user interface element, detection of an interaction with the user interface element causing the CMS to skip the subsequent skippable portion following the non-skippable portion of the in-stream segment.

13. The non-transitory computer storage medium of claim 12, wherein the in-stream segment comprises one of an audio advertisement or a video advertisement.

14. The non-transitory computer storage medium of claim 12, wherein the received user interaction data comprises one or more of click-through data, conversion data, play-through data, or playback duration data associated with the in-stream segment.

15. The non-transitory computer storage medium of claim 12, further comprising:
determining a point in time during playback of the content item based on the received user interaction data, associated with interaction statistics for the in-stream segment, wherein the interaction statistics comprise a highest click-through rate of a plurality of click-through rates associated with the in-stream segment, each click-through rate of the plurality of click-through rates associated with a different position in the in-stream segment; and
identifying, as the non-skippable portion of the content item, a portion of the in-stream segment that includes the determined point in time during playback of the in-stream segment.

16. The non-transitory computer storage medium of claim 12, further comprising:
determining an overall click-through rate, an overall conversion rate, an play-through rate, or an average playback duration associated with the in-stream segment; and
identifying, as the non-skippable portion of the in-stream segment, a beginning of the in-stream segment to an end of the in-stream segment.

17. (canceled)

18. The non-transitory computer storage medium of claim 12, wherein the identified non-skippable portion of the in-stream segment comprises less than an entirety of the in-stream segment.

19. (canceled)

20. A system, comprising: a data processing apparatus; and
a non-transitory computer storage medium encoded with instructions that when executed by the data processing apparatus cause the data processing apparatus to perform operations comprising:
adding, by a processor of a content management system (CMS), an in-stream segment to a content item;
receiving, by the processor, user interaction data corresponding to a plurality of previous user interactions expressing interest in the in-stream segment of the content item, the in-stream segment being defined by at least one point of time during playback of the content item;
for each of the at least one point of time during playback of the in-stream segment, determining, by the processor, from the received user interaction data, a click-though rate for said point of time during playback of the in-stream segment;
determining, by the processor, a first point of time during playback of the in-stream segment having a highest click-through rate, wherein the first point in time is the time elapsed from initiating playback of the in-stream segment;
classifying, by the processor, a portion of the in-stream segment defined by a time of initiating playback of the segment and the first point in time as the non-skippable portion followed by a subsequent skippable portion;
while presenting the in-stream segment of the content item to a user of a client device, detecting, by the processor, that an elapsed time of the presentation of the in-stream segment to the user matches the duration of the non-skippable portion; and
in response to detecting that the elapsed time of the presentation of the content item to the user matches the duration of the non-skippable portion, initiating, by the processor, display of a user interface element, detection of an interaction with the user interface element causing the CMS to skip the subsequent skippable portion following the non-skippable portion of the in-stream segment.
